(19) United States
(12) Patent Application Publication
(10) Pub. No.: US 2002/0143683 A1
(43) Pub. Date: Oct. 3, 2002

(54) Stockholder bonus and participation system

(76) Inventor: Richard Taylor, Spring, TX (US)

Correspondence Address: LAW OFFICES OF CLEMENT CHENG, CLEMENT CHENG, ESQ., DAIMLER CHRYSLER BUILDING, 7700 IRVINE CENTER DRIVE #710, IRVINE, CA, 92618, US

(21) Appl. No.: 10/058,884

(22) Filed: Jan. 28, 2002

Related U.S. Application Data
(63) Continuation-in-part of application No. 09/512,169, filed on Feb. 24, 2000.

(51) Int. Cl. G06F 17/60

(52) U.S. Cl. 705/36; 705/35

(57) ABSTRACT

A system and method for providing a cash income source for stockholders. The invention is adapted for implementation, in part, on a digital computer and the Internet. The invention allows stockholders to earn a cash bonus through participation in qualifying programs. Upon registration of shares, a stockholder is allowed to choose a distinct portion of the corporation's market. The market can be divided in any number of countless schemes such as geographically, demographically, along political boundaries, into zip codes, by area codes, by search queries in the case of a search engine, by flight routes in the case of an airline. The stockholder then receives a cash bonus for activities affecting that market segment. Examples of qualifying activities may include signing up investors for that area, or signing up customers for that area.

### CROSS REFERENCES TO RELATED APPLICATIONS

| | Name of Patentee or | |
|---|---|---|
| Number | Applicant | Date of Publication |
| 5233514 | Ayyoubi | August 3, 1993 |
| 5734838 | Robinson | March 31, 1998 |
| 5193056 | Boes | March 3, 1993 |

### DISCUSSION OF RELATED ART

Currently, many stock investors lose money on their investments. The mediocre situation is due in part to the limited ways a stockholder can profit. Currently, investors profit primarily by trading and dividends. Stock trading is subject to risky market fluctuations. Dividends are unreliable because corporate management can discontinue dividends without notice. Also, few corporations pay cash dividends, and these dividends can be diminished without shareholder approval.

In our global economy it is crucial to motivate stockholders to invest by compensating them for their risk. The capital concentration of most of the world's wealth is in the stock market.

Stockholders and stock exchanges are world's primary capital raising structure. Corporations employ most people in the world. Almost all governments receive their major tax bases from the incomes of the employees of these public corporations. Stockholders are a great corporate resource. Increased stockholder loyalty and excitement about a stock makes a corporation more powerful. Stockholder bases are currently an untapped corporate resource. Empowered stockholders can promote company endeavors. Stockholders should not be seen as apathetic and passive investors.

Special cash benefits are sometimes given to the non-stockholders of a corporation such as employees, officers, directors or even distributors or agents. Stockholders seldom receive the same benefits. Often times executive employees receive a greater cash bonus that dwarfs their salaries. Stockholders seldom receive a bonus that exceeds their dividend. It is unusual to offer a stockholder a bonus greater than the total principal invested by the stockholder. Cash dividends greater than 100% are rare. Investors investing $20,000 usually do not expect to receive a $20,000 cash bonus.

Many systems have presented some minor options and perks for stockholders. Ayyoubi (U.S. Pat. No. 5,233,514) allows stockholders to purchase stock by purchasing products and recording the sales through the scanning of UPC codes. Ayyoubi discloses a unique incentive program of motivating stockholders and product purchasers, but does not allow direct cash investment. A product purchase is necessary. Thus, Ayyoubi's incentive program requires that a stockholder also be a customer.

Robinson U.S. Pat. No. 5,734,838 discloses a method of managing incentive points. General incentive point management without any specification as to what these points can do. Investors may have a hard time turning the Robinson incentive points into money.

Boes U.S. Pat. No. 5,193,056 shows that five investment vehicles included in the ‘Spokes’ system can be centrally managed: (1) Mutual Funds, (2) Pension Funds (under Erisa), (3) Common Trust Funds, (4) Insurance Company Separate Accounts, and (5) Non-US Domiclied Investment Funds. Although the Boes system manages funds in a more efficient manner, it does not offer more money to investors.

Investment in a company or in mutual funds does not allow an investor to invest in particular items of interest such as a particular popular product or popular service. Often times a particular item of interest grabs a potential investor's attention. Upon further research, the inventor may discover that the particular product or service accounts for less than 1% of the public company's revenues and profits. Sometimes the stock that an investor wants to buy is a holding corporation where a popular subsidiary company represents only a fraction of the total sales and revenues of the publicly traded holding company.

### BRIEF SUMMARY OF THE INVENTION

The present invention relates to a system and method for giving stockholders (shareholders of a corporation) a cash bonus known as the sBONU$. The sBONU$ motivates stockholders. The system and method of the present invention is unique because it empowers stockholders to earn an sBONU$. Allowing an alternate stream of cash income encourages investment in the corporation.

sBONU$ is a system and method for providing a cash income source for stockholders. The invention is adapted for implementation, in part, on a digital computer and the Internet. The invention allows stockholders to earn a cash bonus through participation in qualifying programs.

Instead of passively waiting around, a stockholder can register his shares with the corporation after purchase. Upon registration of shares, a stockholder is given sBONU$ Opportunities in proportion to the number of shares purchased. The sBONU$ Opportunities can be cashed in to allow the stockholder to choose a distinct portion of the corporation's market. This discrete market segment can be divided in any number of countless schemes such as geographically, demographically, along political boundaries, by product line, into zip codes, by area codes, by search queries in the case of a search engine, by flight routes in the case of an airline. The stockholder then receives a cash bonus for qualified activities affecting that market segment. Examples of qualifying activities may include signing up investors for that area, or signing up customers for that area.

The sBONU$ System is a departure from traditional mediocrity. In general, the securities laws provide for income without additional work, though stockholders have been given few alternatives to secure any additional cash income except dividends for themselves. The sBONU$ is operable under SEC regulations. The prospectus given to potential inventors will clarify the scope of the income stream and the fact that work is not required of those investors. If necessary, a new prospectus can be drafted for each new program.

### DETAILED DESCRIPTION

I. Introduction

A company seeking to raise money for a new product line or service offering may need investors that are interested particular products. The company can find such investors via traditional marketing strategies where the ability to invest in a new product line or service offering is allowed.

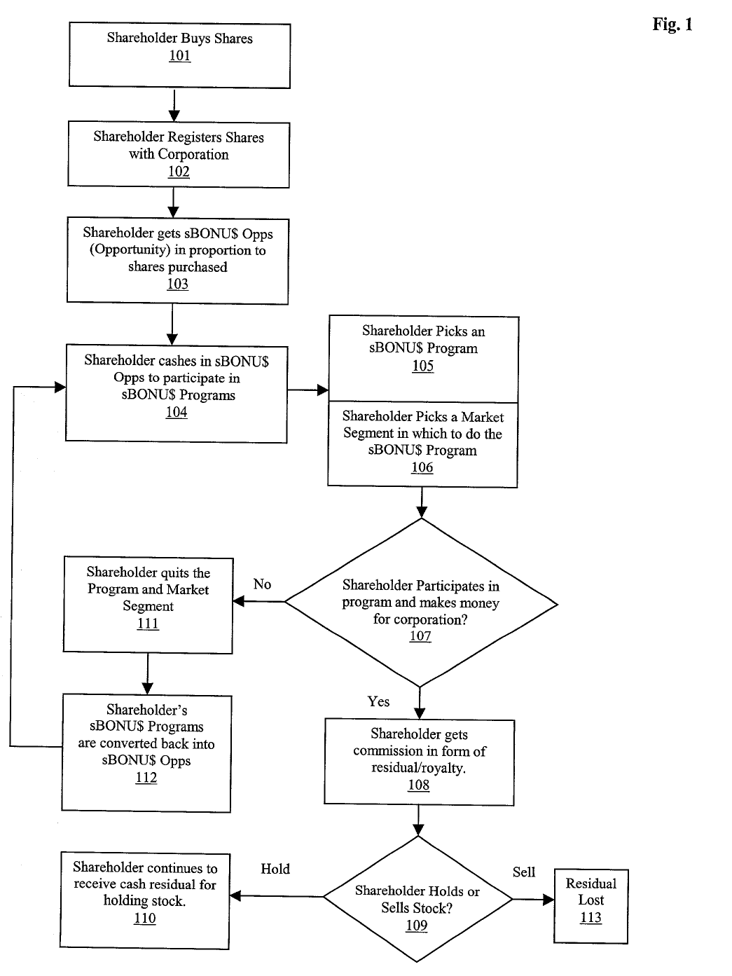

The stockholder first purchases shares 101, FIG. 1. The stockholder can register the shares with the corporation 102, which can be by any number of means such as over the Internet, by phone or in person. Once the shares are registered, the corporate registry reflects a new stockholder. The stockholder becomes a registered user at an internet website or on an intranet website, and has access to a number of points that represent participation opportunities in special incentive programs. The default relationship gives one point for each share purchased.

In the preferred implementation, the corporation supplies a list of programs and stockholder investment information to an ASP (Application Service Provider). The ASP server puts the programs list on the Internet so that potential investors and stockholders can view program details. The ASP gives the stockholder a password and login to allow the stockholder to buy into a participation program. The corporate registry preferably stored as a computer database can send new user data to the ASP server which increments for the stockholder a certain number of sBONU$ opportunity points 103.

II. The Standard Program

The standard program offers a stockholder a residual on a ‘product line’. A model number or a group of related model numbers could identify a product line sold by the company. The stockholder who has chosen the particular product line receives a steady stream of money. The money is a percentage of the gross sales on that product line.

The investor retains the traditional benefits of stock ownership such as stock price increases, dividends, and colorful annual reports. The investor also receives an additional residual tied to the product line. The residual must be paid and is not vulnerable to traditional stock investor woes such as stock price dilution due to excessive corporate executive bonuses, stock price drops due to market volatility, or the discontinuation of dividends by the board.

Analogously, a ‘product line’ in a product based company can be translated into a ‘service offering’ for a service based company. The ‘service offering’ may be defined and identified with a billing code or by location such as by the zip code where services are performed.

A market segment must be a distinct portion of a company's business that can be partitioned and separately accounted for. The market segment can be any distinct limitation on the terms under which the residual bonuses apply. The market segments 106 can be stated as limitations of various natures: within certain product lines, within certain service offerings, within certain geographical regions, within demographics, within certain zip codes, within certain area codes, by search queries in the case of a search engine, or by flight routes in the case of an airline. The market segments and other specific information can be found in the prospectus or stockholder information brochure.

For example, a Christmas tree farm may have 5 fields with 500 trees each. Here, an sBonu$ investor could be given a percentage of the gross sales on the market segment of trees sold from a particular field. The amount called the sBonu$ can motivate the investor to hold the stock, or perhaps monitor and visit his particular field, should he live nearby. The sBonu$ investor stockholder often receives a percentage of the corporation's gross income from a particular market segment or project. The percentage of the corporation's gross income is targeted to motivate the investor stockholder.

III. Program Operation

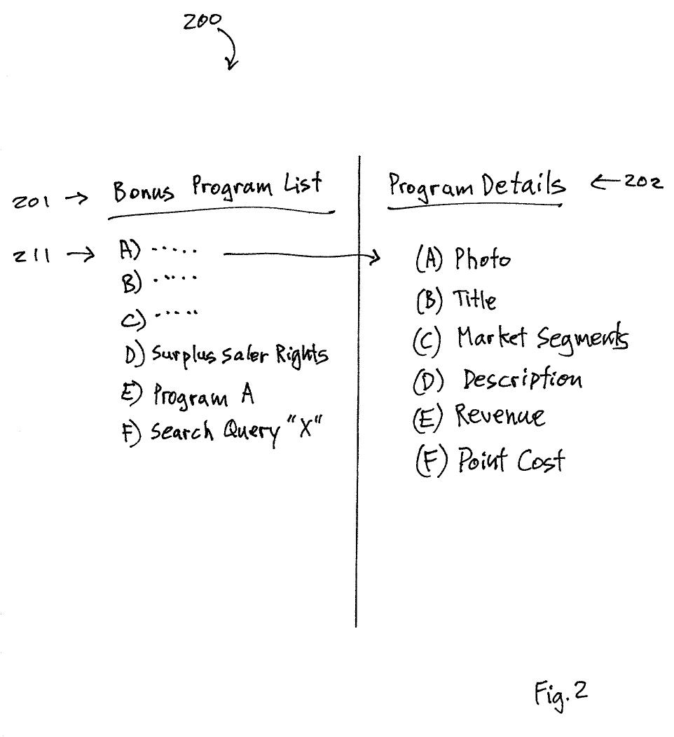

After a potential investor visits the ASP website, he can find a program of interest from the program list FIG. 2, 201. The stockholder can log on via the Internet to view a list of sBONU$ programs FIG. 2, 211. The program list preferably has a list of programs in one column FIG. 2, 201. A visitor or stockholder can select a program of interest that displays program details in the second column FIG. 2, 202. Program Detail Information is generated from field codes that query the program detail array on the ASP server website.

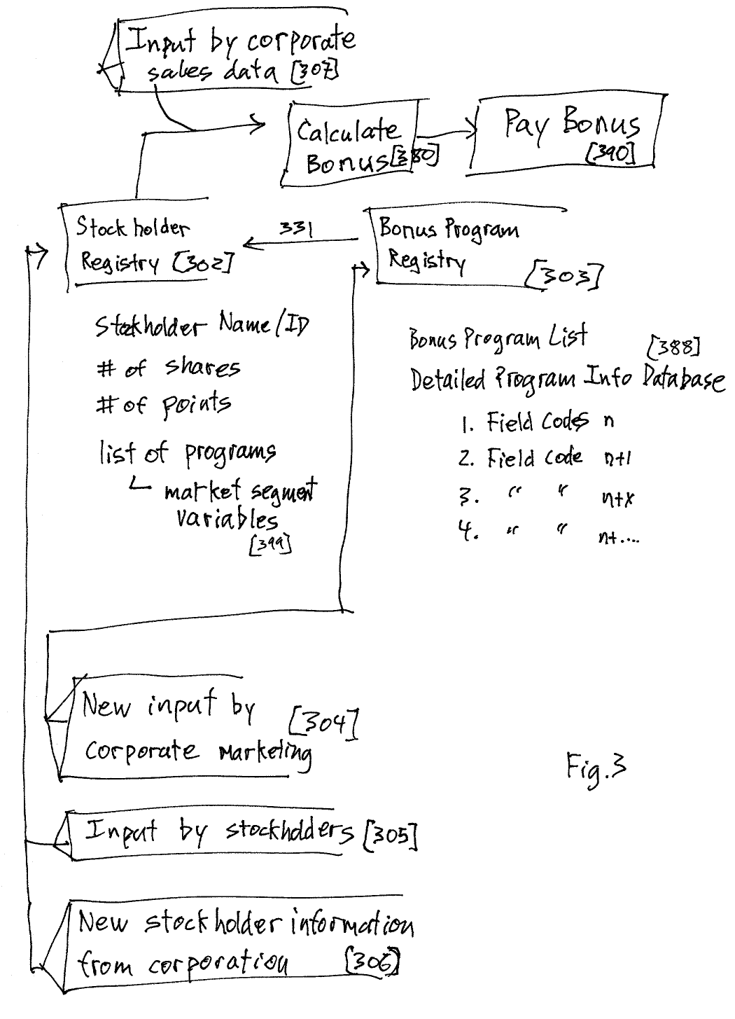

In the standard program that offers a residual cash bonus for a product, the field codes would include: FIG. 3, 303 (A) a Photo of the included products or services; (B) Title offering a brief description of the product; (C) A narrative description; (D) the market segment which is a limitation such as the product or service identifier number such as the model number, UPC or SKU; or the geographical area where residuals apply to product sales; (E) the revenue structure; and (F) the number of points needed to buy into the program. Any number (n) of field codes may be used. The stockholder then receives a percentage of the gross revenues on a particular product sold for as long as the stock is held FIG. 3, 390. The participating corporation can update the field codes under an administration function as new products are introduced. FIG. 3, 304.

While the ASP queries the Program Detail Information database FIG. 3, 388, the ASP also queries a database having user information FIG. 3, 302. A visitor or a stockholder user that did not log in sees a zero balance. A stockholder may purchase additional programs until his balance of points is exhausted. When the stockholder has spent his points, he can call his broker or go to his online brokerage account to purchase the amount of stock necessary to buy into the program.

A stockholder can spend the sBONU$ Opps to buy into an sBONU$ program 105. Sometimes a corporation sees that some programs may be very popular. The selection of the programs can be changed to add an auction variation. In this variation, particularly popular programs can be auctioned to the highest bidder. A new program can be announced weeks in advance. Stockholders can bid their points during the auction period. After the auction closes the winning stockholder receives the rights to the program.

Some sBONU$ programs may have a market segment 106. Programs that are available corporate wide are not limited to any particular market segment. The market segments and the programs in the market segments are given to stockholders on a first come first served basis. Thus, each investor has an individual and distinct right to his sBONU$ under the rules of the corporation and the prospectus.

For example, a stockholder could buy 10000 shares of a paging service corporation. These shares are just like any other shares publicly traded, except that they also entitle her to 10000 points of sBONU$ Opps. She can then choose among different sBONU$ programs 104. She could choose to redeem 5000 of these sBONU$ Opps points to enroll in the sBONU$ customer referral program for the area code that she lives in. By referring her friends, family and coworkers to sign up for pagers at the paging service corporation, she is making money for the corporation. Signing up a customer is also an optional participation in company affairs 107.

The corporation makes note of her referrals and gives her a residual also called an sBONU$ 108. In this case she could get a quarterly check equal to 15% of the gross income derived from the customers in her area. This residual sBONU$ would be in addition to whatever dividend she gets. She can use her remaining 5000 points of sBONU$ Opps to buy into another program. With a wide range of programs, the stockholder never gets bored. The stockholder may abandon a program at any time and receive a refund of unused points.

Basic Functions List

a. New stockholder data FIG. 3, 306 is written on a stockholder registry FIG. 3, 302 when a stockholder purchases stock for the first time, incrementing participation points in proportion to stock purchased,

b. New stockholder data is written on a stockholder registry when a stockholder purchases or sells shares in a corporation, adjusting participation points in proportion to stock purchased or sold, removing 331 a program from a stockholder's list of programs when a stockholder's participation points drop below a required number of participation points,

c. The bonus program registry receives new bonus program data written when a corporation starts a new bonus program, FIG. 3, 304

d. An available bonus program list with program details is provided to a registered stockholder, FIG. 3, 388, FIG. 2, 200

e. The system records 331 a stockholder's purchase selection of an available bonus program by: writing bonus program field codes into the stockholder registry, deleting 331 said bonus program from the available bonus program records, deducting 331 an applicable number of points from the stockholder's account in the stockholder registry,

f. The system receives financial data including sales data from the participant corporation, said sales data containing gross sales and sales under certain market segment variables, FIG. 3, 307.

g. The system weighs current available stockholder participation points against a cost value required to purchase a bonus program, and disallowing a bonus program purchase if said available stockholder participation points do not equal or exceed the required bonus program points cost value, FIG. 3, 305, 302.

h. The system calculates disbursements to stockholders 390 by: matching market segment variables in sales data with the same market segment variables in the stockholder registry; and multiplying sales revenue in sales data by the residual percentage field to obtain the stockholder disbursement.

One way to do the calculation FIG. 3, 380 is to simply use two arrays where the first is an indicator array having zeros and ones representing market segment variables from sales data 307, the ones signifying that a condition is required. The second array is that of the stockholder's market segments 399. Field matching can be done by a simple matching algorithm or by multiplying the cells of the arrays. Matched fields produce a value that is multiplied by the residual bonus percentage to calculate 380 the amount of money for the stockholder.

IV. Field Code and Program Examples 388

sBONU$ #1

(A) Photo: (a picture of a newspaper ad)

(B) Title: Surplus Sales Rights

(C) Description: This program gives a stockholder the rights to proceeds from the sales of surplus newspaper advertising.

(D) Market Segment: Baltimore Herald, in area code 202, Sunday Edition, advertising not sold one week before advertising deadline. Advertising sold at at least 70% of retail list price on normal price sheet.

(E) Revenue: Stockholder receives half of gross for advertising sold. (note the stockholder may rely on newspaper's internal sales team or may actively seek buyers)

(F) Points: 3,000

sBONU$ #2

(A) Photo: (a picture of a client)

(B) Title: Future Client Referrals

(C) Description: The stockholder names a potential client who is reserved for three years.

(D) Market Segment: One client

(E) Revenue: Stockholder receives 1% of gross sales to that client during the three years. (note: the stockholder may actively solicit the client's business or do nothing)

(F) Points: 1,000

sBONU$ #4

(A) Photo: (none)

(B) Title: Search Query “Computer”

(C) Description: Search engine gives Stockholder a bonus on all revenue from this search query.

(D) Market Segment: One search query “Computer”, revenue on advertisement or paid placement in the page brought up by the search query “Computer”

(E) Revenue: Stockholder receives 1% of gross sales.

(F) Points: Auction begins at 1,000 points on Feb. 2, 2003 and closes in 3 days.

sBONU$ #5

Photo: (a map of Texas and a picture of model GS3422)

Title: Distributor Regions

Description: Stockholder receives a bonus for sales in of the GS3422 in Texas.

Market Segment: one product line GS3422 retail sales, Texas

Revenue: Stockholder receives 6% of gross sales.

Points: 1,200

sBONU$ #6

(A) Photo: (a stylized lettering featuring the words “10% off”)

(B) Title: 10% off

(C) Description: Stockholder receives same discount as employee discount.

(D) Market Segment: purchases made by stockholder, retail stores

(E) Revenue: Stockholder receives a 10% residual on gross sales that the stockholder makes.

(F) Points: 3,400

V. Residual form of Cash Bonuses

In 108, FIG. 1, the Stockholder gets the sBONU$, a residual which can also be called a royalty or commission in certain cases. The sBONU$ residual could be called a commission such as if it awards successful participation in an sBONU$ program. The sBONU$ residual could be called a royalty such as if it awards a percentage of licensing revenue from a particular company patent.

The residual form of the sBONU$ is lost as shown in 113 once a stockholder sells the stock. The sBONU$ system promotes long term holding of shares 110 instead of speculation. The stockholder always has a decision to hold or sell 109. The loss of the residual will deter the stockholder from selling, and give more price stability.

VI. Conclusion

The sBONU$ system pays stockholders in different amounts and for different reasons. The corporation can encourage stockholder participation by offering different levels of benefits, based on participation or performance, to increase the benefits going to certain stockholders. Stockholders can additionally be given a rating denoting their ability to generate revenue for the corporation. The highest earning stockholders might also be given special benefits to encourage stockholders participation. Each stockholder retains a secure investment. Although special benefits may be given to more productive stockholders, unlike dividends, the sBONU$ cannot be unilaterally eliminated by the corporate management.

The share price of a corporation using the sBONU$ system would be higher and more stable. The share price would reflect the additional value of the sBONU$ programs and opportunities. Investors no longer look solely to the share price to determine profit potential. Investors can be more enthusiastic because the sBONU$ residual cash income offers them a cushion for solid investment returns.

The current capital market favors large corporations who are seen as stronger and safer. Access to capital often determines success. The sBONU$ system provides small corporations a new and different way to excite and motivate investors. The sBONU$ system also enfranchises investors with substantial income, even in a volatile market.

1. A method of distributing a bonus cash income source to stockholders of a corporation, comprising the steps of:
a. Maintaining a stockholder registry on an ASP server comprising:
i. A stockholder identifier,
ii. Amount of stock held by each stockholder,
iii. Amount of participation points available to each stockholder,
iv. A list of programs owned by each stockholder, and
V. A list of market segment variables of each of said programs owned by each stockholder,
b. Maintaining a bonus program registry in on an ASP server comprising:
vi. A bonus program list,
vii. A detailed program information database organized by field codes,
viii. Said field codes including at least the following fields: cost in points; revenue description; residual percentage; and a list of market segments, said market segments offering discrete division and identification of revenue streams within a corporation,
c. Receiving new stockholder data written on a stockholder registry when a stockholder purchases stock for the first time, incrementing participation points in proportion to stock purchased,
d. Receiving new stockholder data written on a stockholder registry when a stockholder purchases or sells shares in a corporation, adjusting participation points in proportion to stock purchased or sold, removing a program from a stockholder's list of programs when a stockholder's participation points drop below a required number of participation points,
e. Receiving new bonus program data written on a bonus program registry when a corporation starts a new bonus program,
f. Providing an available bonus program list with program details to a registered stockholder,
g. Recording a stockholder's purchase selection of an available bonus program by: writing bonus program field codes into said stockholder registry, deleting said bonus program from the available bonus program records, deducting an applicable number of points from the stockholder's account in the stockholder registry,
h. Receiving financial data including sales data from the participant corporation, said sales data containing gross sales and sales under certain market segment variables,
i. Weighing current available stockholder participation points against a cost value required to purchase a bonus program, and disallowing a bonus program purchase if said available stockholder participation points do not equal or exceed the required bonus program points cost value,
j. Calculating disbursements to stockholders by: matching market segment variables in sales data with the same market segment variables in the stockholder registry; and multiplying sales revenue in sales data by the residual percentage field to obtain the stockholder disbursement.

2. The method as in claim 1 of distributing a bonus cash income source to stockholders of a corporation, wherein a royalty or residual is calculated by multiplying the gross sales having the qualifying market segment coding and the residual percentage.

3. The method as in claim 1 of distributing a bonus cash income source to stockholders of a corporation, wherein said field codes are:
(A) Photo: (a picture of a newspaper ad),
(B) Title: Surplus Sales Rights,
(C) Description: This program gives a stockholder the rights to proceeds from the sales of surplus newspaper advertising,
(D) Market Segment: Baltimore Herald, in area code 202, Sunday Edition, advertising not sold one week before advertising deadline, advertising sold at at least 70% of retail list price on normal price sheet,
(E) Revenue: Stockholder receives half of gross for advertising sold. (note the stockholder may rely on newspaper's internal sales team or may actively seek buyers),
(F) Points: 3,000.

4. The method as in claim 1 of distributing a bonus cash income source to stockholders of a corporation, wherein said field codes are:
(A) Photo: (a picture of a client),
(B) Title: Future Client Referrals,
(C) Description: The stockholder names a potential client who is reserved for three years,
(D) Market Segment: One client,
(E) Revenue: Stockholder receives 1% of gross sales to that client during the three years (note: the stockholder may actively solicit the client's business or do nothing),
(F) Points: 1,000.

5. The method as in claim 1 of distributing a bonus cash income source to stockholders of a corporation, wherein said field codes are:
(A) Photo: (none),
(B) Title: Search Query “Computer”,
(C) Description: Search engine gives Stockholder a bonus on all revenue from this search query,
(D) Market Segment: One search query “Computer”, revenue on advertisement or paid placement in the page brought up by the search query “Computer”,
(E) Revenue: Stockholder receives 1% of gross sales,
(F) Points: Auction begins at 1,000 points on Feb. 2, 2003 and closes in 3 days.

6. The method as in claim 1 of distributing a bonus cash income source to stockholders of a corporation, wherein said field codes are:
(A) Photo: (a map of Texas and a picture of model GS3422),
(B) Title: Distributor Regions,
(C) Description: Stockholder receives a bonus for sales in of the GS3422 in Texas,
(D) Market Segment: one product line GS3422 retail sales, Texas,
(E) Revenue: Stockholder receives 6% of gross sales,
(F) Points: 1,200.

7. The method as in claim 1 of distributing a bonus cash income source to stockholders of a corporation, wherein said field codes are:
(A) Photo: (a stylized lettering featuring the words “10% off”)
(B) Title: 10% off
(C) Description: Stockholder receives same discount as employee discount
(D) Market Segment: purchases made by stockholder, retail stores
(E) Revenue: Stockholder receives a 10% residual on gross sales that the stockholder makes.
(F) Points: 3,400

8. A method of providing a cash income source for shareholders of a corporation, comprising the steps of:
k. maintaining records in a digital computer of at least:
i. a list of qualifying programs for shareholders,
ii. a list of market segments chosen by each shareholder, said market segments dividing the revenue source of the corporation into discrete units, and
iii. a list of bonuses to be paid to stockholders,
l. allowing the shareholder to purchase stock;
m. allowing the shareholder to choose a number of market segments in proportion to the number of shares purchased by said shareholder;
n. allowing the shareholder to choose various qualifying programs for the market segments that the shareholder chooses to participate in;
o. paying a residual cash bonus to shareholders for as long as said shareholders own the stock.

9. The method of claim 8, wherein step (a) includes records storage of shareholder shares registration and sBONU$ Opp Points balances.

10. The method of claim 8, wherein step (c) includes giving one or more sBONU$ Opp Points in proportion to the number of shares purchased by a shareholder.

11. The method of claim 8, wherein step (d) includes allowing a shareholder to buy into an sBONU$ program using sBONU$ Opp Points.

12. The method of claim 8, further including between step (d) and step (e) the additional step of: (d2) determining shareholder productivity by revenue generation.

13. The method of claim 8, wherein step (c) includes giving one or more sBONU$ Opp Points in proportion to the number of shares purchased by a shareholder, wherein step (d) includes allowing a shareholder to buy into an sBONU$ program using sBONU$ Opp Points.

14. The method of claim 8 further including step (d3) continuing to give the shareholder a residual cash bonus for as long the shareholder holds the stock.

15. The method of claim 8, further including step (d4) discontinuing an individual shareholder's program if the shareholder expressly abandons the program or does not meet pre-set performance quotas.

16. The method of claim 8, further including step (d5) refunding a portion up to the whole of sBONU$ Opp Points spent to buy into an sBONU$ program; and further including step (d6) allowing a shareholder to re-spend sBONU$ Opp Points to buy into an sBONU$ program.
